(19) United States
(12) Patent Application Publication
(10) Pub. No.: US 2024/0378515 A1
(43) Pub. Date: Nov. 14, 2024

(54) GENERATION APPARATUS, GENERATION METHOD, DATA STRUCTURE OF MODEL DATA, DATA STRUCTURE OF RELATION DATA AND GENERATION PROGRAM

(71) Applicant: Nippon Telegraph and Telephone Corporation, Tokyo (JP)

(72) Inventors: Mizuto NAKAMURA, Musashino-shi, Tokyo (JP); Ryosuke SATO, Musashino-shi, Tokyo (JP); Kyoko YAMAGOE, Musashino-shi, Tokyo (JP)

(21) Appl. No.: 18/580,723

(22) PCT Filed: Jul. 21, 2021
(86) PCT No.: PCT/JP2021/027335

§ 371 Date: Jan. 19, 2024

(51) Int. Cl. G06Q 10/06

(52) U.S. Cl. CPC G06Q 10/06

(57) ABSTRACT

The generation device 1 includes an acquisition unit 21 that acquires an execution ID of an executed workflow and scenario information of the workflow from a workflow engine 4, a first generation unit 23 that acquires basic information of each of AI models 8 included in the scenario information and execution time information at the time of execution of the workflow for each of the AI models 8, and generates model state information using the basic information and the execution time information, and a second generation unit 24 that generates relation data in which the model state information and the scenario information are associated with the execution ID.

### TECHNICAL FIELD

The present invention relates to a generation device, a generation method, a data structure of model data, a data structure of relation data, and a generation program.

### BACKGROUND ART

In order to achieve zero-touch operation, introduction of AI (AI model) is in progress, and automation of handling in operation using AI is being studied.

There is an AutoML tool that automates a learning process of model tuning of AI and constructs an optimal model (Non Patent Literature 1). Further, research on learning management for monitoring the accuracy of AI has also been reported (Non Patent Literature 2).

### CITATION LIST

### Non Patent Literature

Non Patent Literature 1: “Amazon SageMaker”, Amazon Web Services, Inc., the Internet <https://aws.amazon.com/jp/sagemaker/>
Non Patent Literature 2: Sebastian et. al, “Automatically tracking metadata and provenance of machine learning experiments”, In Machine Learning Systems workshop at NIPS2017, the Internet <https://www.amazon.science/publications/automatically-tracking-metadata-and-provenance-of-machine-learning-experiments>

### SUMMARY OF INVENTION

### Technical Problem

In an operation in which AI is linked by a workflow, there is a description of which AI is linked in which process in the scenario, and thus it is possible to operate a data flow through the same AI again using the same scenario.

However, output of AI varies depending on a model state of the AI, and the AI may be subjected to model update or tuning in accordance with an environmental change. Thus, when a determination error of AI is found, it is difficult to ensure reproduction of the operation at the time of the determination.

For example, in a case where an error is found in automatic handling three hours ago in automatic handling by a device failure handling scenario that calls a plurality of AIs performing inference such as abnormality detection, alarm clustering, and root cause analysis (RCA), a reproduction test cannot be performed unless the state of the AI at the time of execution of the automatic handling can be specified. Therefore, the cause of the error cannot be specified, and measures for preventing recurrence cannot be taken.

In Non Patent Literature 1, learning management and a reproduction test of each AI can be performed but cannot be associated with a workflow, and thus it is difficult to reproduce a workflow engine and a data flow using a plurality of AIs.

Non Patent Literature 2 reproduces and manages a learning process of a specific AI by describing an adapter from scratch, but does not consider cooperation with a workflow engine. In addition, in Non Patent Literature 2, it is necessary to describe a code from scratch for each AI, and it is not efficient to use a plurality of AIs.

The present invention has been made in view of the above circumstances, and an object of the present invention is to manage a state of AI in an execution unit of workflow.

### Solution to Problem

In order to achieve the above object, one aspect of the present invention is a generation device including an acquisition unit that acquires an execution ID of an executed workflow and scenario information of the workflow from a workflow engine, a first generation unit that acquires basic information of each of AI models included in the scenario information and execution time information at a time of execution of the workflow for each of the AI models, and generates model state information using the basic information and the execution time information, and a second generation unit that generates relation data in which the model state information and the scenario information are associated with the execution ID.

One aspect of the present invention is a generation method performed by a generation device, the method including acquiring an execution ID of an executed workflow and scenario information of the workflow from a workflow engine, acquiring basic information of each of AI models included in the scenario information and execution time information at a time of execution of the workflow for each of the AI models, and generating model state information using the basic information and the execution time information, and generating relation data in which the model state information and the scenario information are associated with the execution ID.

One aspect of the present invention is a data structure of model data indicating an AI model, the model data being stored in a storage unit of a generation device, the data structure including basic information of the AI model, and a plurality of pieces of model state information generated for each execution of a workflow including the AI model, in which the model state information includes an execution ID that is set for each execution of the workflow, and a processing unit of the generation device is used for processing of specifying the model state information and the basic information of each AI model including a designated execution ID.

One aspect of the present invention is a data structure of relation data indicating a relationship between a workflow and a plurality of AI models included in the workflow, the relation data being stored in a storage unit of a generation device, the data structure including an execution ID that is set for each execution of the workflow, scenario information of the workflow, and model state information of each of the AI models, in which a first pointer to corresponding scenario information and a second pointer to corresponding model state information are added to the execution ID, and a processing unit of the generation device is used for processing of specifying the scenario information and the model state information corresponding to the designated execution ID according to the first pointer and the second pointer.

One aspect of the present invention is a generation program for causing a computer to function as the generation device.

### Advantageous Effects of Invention

According to the present invention, it is possible to manage a state of AI for an execution unit of workflow.

### BRIEF DESCRIPTION OF DRAWINGS

FIG. 1 is a system configuration diagram illustrating a system of an embodiment of the present invention.

FIG. 2 is a block diagram illustrating a configuration of a generation device.

FIG. 3 is an explanatory diagram for describing model data and relation data.

FIG. 4 is a flowchart illustrating an operation of the generation device.

FIG. 5 is a hardware configuration example.

### DESCRIPTION OF EMBODIMENTS

Hereinafter, an embodiment of the present invention will be described with reference to the drawings.

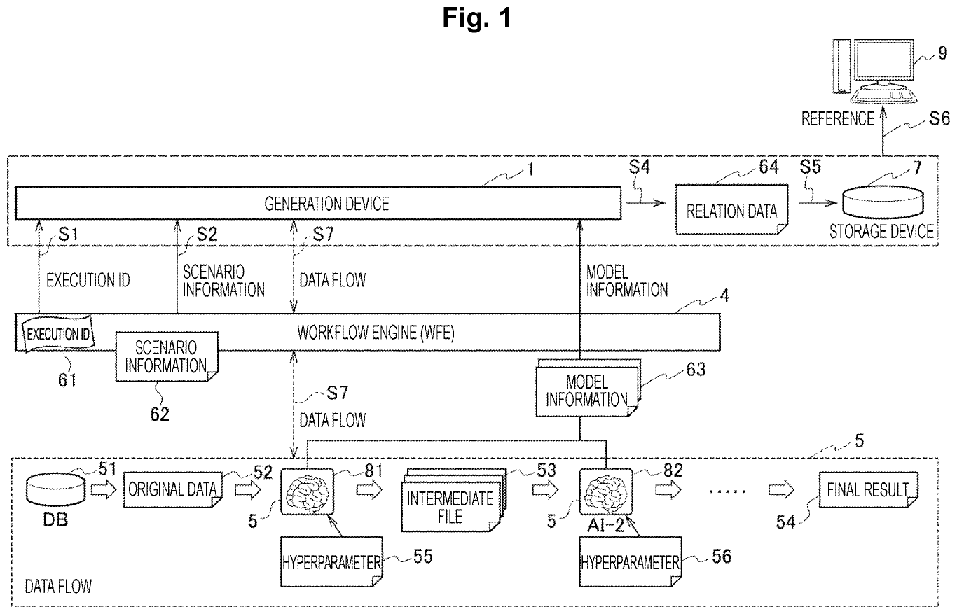

FIG. 1 is a system configuration diagram illustrating a system of the present embodiment. The illustrated system includes a generation device 1, a workflow engine 4, and a plurality of AI models 8-1 and 8-2.

In the workflow in which the plurality of AI models 8-1 and 8-2 is linked, the generation device 1 generates relation data that enables management of the model state of each of the AI models 8-1 and 8-2 in an execution unit of workflow. Further, the generation device 1 can manage, in a workflow in which the plurality of AI models 8-1 and 8-2 is linked, the model state of each of the AI models 8-1 and 8-2 and the relationship of a data flow 5 in association with each other in the execution unit of workflow.

The workflow engine 4 executes a workflow according to scenario information 62 in which the workflow execution procedure is defined. The scenario information 62 may be held in a database inside the workflow engine 4 or may be held in a database outside the workflow engine 4.

In the data flow 5 of the illustrated scenario information 62, original data 52 extracted from a DB 51 is input to the AI model 8-1, and the AI model 8-1 outputs an intermediate file 53. Then, the intermediate file 53 is input to the AI model 8-2, and a final result 54 is output through processing (not illustrated). In the illustrated example, two AI models 8-1 and 8-2 are illustrated, but one or three or more AI models 8 may be used in the scenario information 62.

Here, hyperparameters 55 and 56 are set in the AI models 8-1 and 8-2, respectively. The hyperparameters 55 and 56 are parameters for the administrator to adjust the AI models 8-1 and 8-2 from the outside. The hyperparameters 55 and 56 are set and executed by the administrator, and thus are described in log information when the AI models 8-1 and 8-2 are executed.

The original data 52, the intermediate file 53, the final result 54, and the hyperparameters 55 and 56 of the data flow 5 are stored in a storage unit (not illustrated) of the workflow engine 4 for each execution of the workflow.

The AI models 8-1 and 8-2 (hereinafter may also be referred to as “AI model 8”) are machine learning models generated by machine learning. In the present embodiment, the AI model 8 generated by using the online machine learning is used. The online machine learning is machine learning that learns and updates the AI model 8 every time data is given. Note that the machine learning of the AI model 8 is not limited to the online machine learning, and other machine learning (for example, batch machine learning or the like) may be used.

The workflow engine 4 dispenses an execution ID 61 every time the workflow is executed, and transmits the execution ID to the generation device 1 as execution information (S1).

Upon receiving the execution ID 61, the generation device 1 acquires the scenario information 62 of the executed workflow from the workflow engine 4 (S2). Further, the generation device 1 acquires model information 63 from each of the AI models 8-1 and 8-2 (S3). The model information 63 includes basic information of the AI model 8 and execution time information indicating the AI model 8 at the time of executing the workflow.

The generation device 1 generates and outputs relation data 64 using the execution ID 61, the scenario information 62, and the model information 63 acquired in S1 to S3 (S4). The relation data 64 may be stored inside the generation device 1 or may be stored in the external storage device 7 (S5).

The operator refers to the relation data 64 using the operation terminal 9 (S6). Thus, it is possible to ensure reproducibility of the data flow using the plurality of AI models 8. Specifically, even when the AI model 8 is introduced into the workflow of operation to be actually operated and some trouble occurs, it is possible to perform test and debugging for each AI model 8, and it is possible to isolate and improve a cause portion. That is, since the AI model 8 and the data flow 5 can be specified by referring to the relation data 64, the data flow 5 when a failure occurs can be reproduced. The operation terminal 9 may execute a workflow reproduction test using the relation data 64.

Note that the generation device 1 may acquire the pieces of data 52, 53, 54, 55, and 56 of the data flow 5 from the workflow engine 4 and store the pieces of data in the storage unit of the generation device 1 (S7).

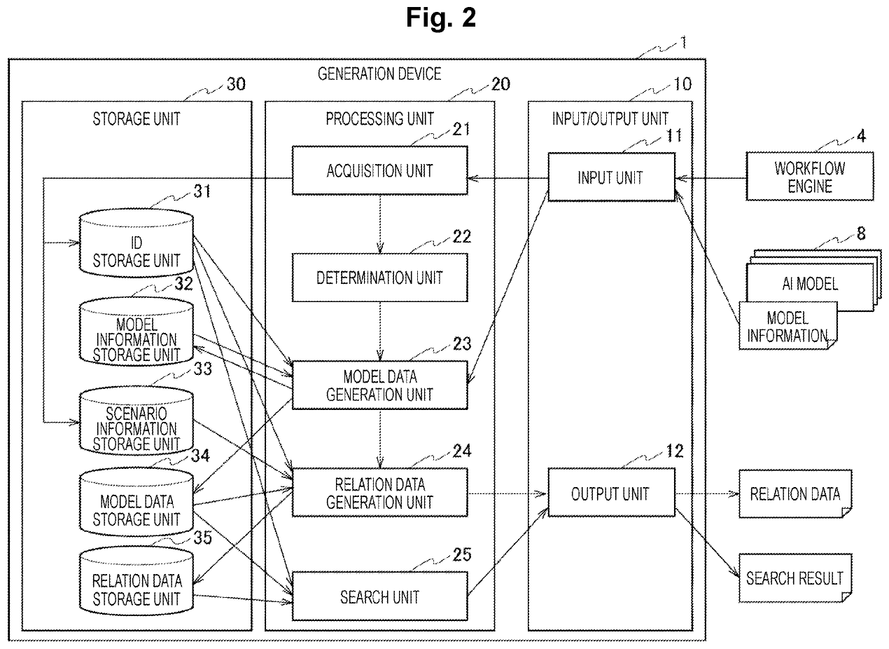

FIG. 2 is a block diagram illustrating a configuration of the generation device 1 of the present embodiment. The generation device 1 generates relation data indicating the relationship between the workflow and the plurality of AI models 8 included in the workflow. The generation device 1 generates model data indicating the AI model 8.

The illustrated generation device 1 includes an input/output unit 10, a processing unit 20, and a storage unit 30.

The input/output unit 10 includes an input unit 11 and an output unit 12. The input unit 11 receives inputs of an execution ID and scenario information transmitted from the workflow engine 4, and sends them to an acquisition unit 21. The input unit 11 receives inputs of model information transmitted from each AI model 8 and sends the model information to a model data generation unit 23. The output unit 12 outputs relation data generated by a relation data generation unit 24.

The processing unit 20 includes the acquisition unit 21, a determination unit 22, the model data generation unit 23 (first generation unit), the relation data generation unit 24 (second generation unit), and a presentation unit 25.

The acquisition unit 21 acquires an execution ID (execution information) of the executed workflow and scenario information of the workflow from the workflow engine 4 via the input unit 11.

The determination unit 22 analyzes the scenario information and determines whether or not the AI model 8 is included in the scenario information. When the AI model 8 is included, the determination unit 22 instructs the model data generation unit 23 to acquire model information of each AI model 8.

When the AI model 8 is included in the scenario information, the model data generation unit 23 acquires the basic information of each AI model 8 included in the scenario information and the execution time information at the time of executing the workflow from each AI model 8 via the input unit 11. The basic information and the execution time information will be described later. The execution time information at the time of executing the workflow indicates the state of the AI model 8 immediately before execution of the workflow.

The model data generation unit 23 generates model state information using the basic information and the execution time information for each AI model 8. The model data generation unit 23 may generate a difference between the basic information and the execution time information as the model state information. The model data generation unit 23 assigns an execution ID to the model state information, and generates model data including basic information and a plurality of pieces of model state information to which the execution ID is assigned for each AI model 8. The model data generation unit 23 may use, for example, a model card of the following document for generation of model data.

Margaret Mitchell, et. al, “Model Cards for Model Reporting”, In FAT* '19: Conference on Fairness, Accountability, and Transparency, Jan. 29-31, 2019

The relation data generation unit 24 generates relation data in which the model state information and the scenario information are associated with the execution ID. The relation data generation unit 24 may set a first pointer to the corresponding scenario information and a second pointer to the corresponding model state information to each execution ID stored in an ID storage unit 31. A storage location (for example, an address) of information to be associated (information of a link destination) is set to the pointer.

The relation data generation unit 24 may set the address of the scenario information of the workflow executed with the execution ID to the first pointer and set the address of the model state information generated with the execution ID to the second pointer.

The search unit 25 specifies the model state information and the basic information of each AI model 8 to which the execution ID designated from the operation terminal 9 or the like is assigned, transmits the specified model state information and basic information (search results) to the operation terminal 9 via the output unit 12, and presents the model state information and the basic information to the operator.

The search unit 25 specifies the scenario information and the model state information corresponding to the execution ID designated from the operation terminal 9 or the like according to the first pointer and the second pointer. Then, the search unit 25 transmits the specified model state information and scenario information (search result) to the operation terminal 9 via the output unit 12 to present to the operator.

The storage unit 30 includes the ID storage unit 31, a model information storage unit 32, a scenario information storage unit 33, a model data storage unit 34, and a relation data storage unit 35.

The ID storage unit 31 stores an execution ID transmitted from the workflow engine 4. The model information storage unit 32 stores model information acquired from each AI model 8. The model information includes the basic information of the AI model 8 and the execution time information at the time of executing the workflow.

The scenario information storage unit 33 stores scenario information acquired from the workflow engine 4.

The model data storage unit 34 stores the model data of each AI model 8 generated by the model data generation unit 23. The data structure of the model data includes the basic information of the AI model 8 and a plurality of pieces of model state information generated for each execution of a workflow including the AI model 8, and the model state information includes an execution ID that is set for each execution of the workflow. The model data is used for processing in which the search unit 25 designates the model state information and the basic information of each AI model 8 including the specified execution ID. By inputting a desired execution ID to the generation device 1 using the operation terminal 9 or the like, the operator can acquire the model state information of the AI model 8 at the time of executing the workflow of the execution ID and reproduce the AI model 8 at the time of executing the workflow in the past.

The relation data storage unit 35 stores the relation data indicating the relationship between the workflow and the plurality of AI models 8 included in the workflow. The relation data of the present embodiment includes the execution ID that is set for each execution of the workflow, the scenario information of the workflow, and the model state information of each AI model 8, and the first pointer to the corresponding scenario information and the second pointer to the corresponding model state information are added to the execution ID.

The relation data is used for processing in which the search unit 25 specifies the scenario information and the model state information corresponding to the designated execution ID according to the first pointer and the second pointer. By inputting a desired execution ID to the generation device 1 using the operation terminal 9 or the like, the operator can acquire the scenario information at the time of executing the workflow of the execution ID and the model state information of the AI model 8, and reproduce the data flow at the time of executing the workflow in the past.

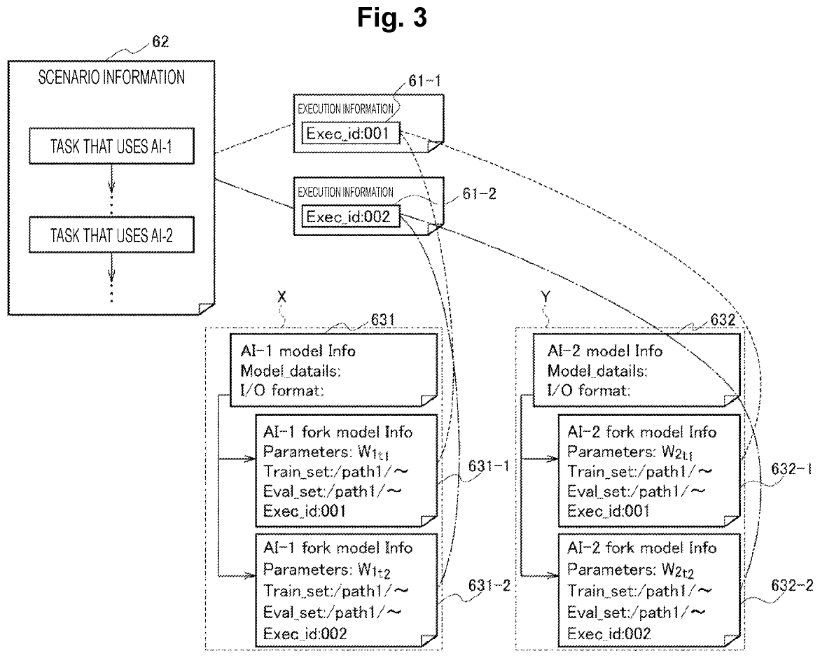

FIG. 3 is an explanatory diagram for describing model data of the AI model 8 and relation data. In the illustrated scenario information 62, two AI models 8 (AI-1, AI-2) are used.

Every time the workflow is executed, the generation device 1 stores the execution IDs (execution information) 61-1 and 62-2 notified from the workflow engine 4 in the ID storage unit 31.

The generation device 1 generates model data X of the AI model 8 (AI-1) and model data Y of the AI model 8 (AI-2), and stores the model data X and the model data Y in the model data storage unit 34. The model data X of the AI model 8 (AI-1) includes basic information 631 and a plurality of pieces of model state information 631-1 and 631-2 generated for each execution of the workflow. The model data Y of the AI model 8 (AI-2) includes basic information 632 and a plurality of pieces of model state information 632-1 and 632-2.

The basic information (model Info) 631 and 632 include information that does not change with time due to execution of the workflow, such as the machine learning method of the AI model 8 and the formats of input and output.

The model state information (fork model Info) 631-1, 631-2, 632-1, and 632-2 includes information that changes with time due to execution of the workflow, such as internal parameters of the AI model 8. The internal parameter is, for example, a weight parameter of the neural network, or the like. The model state information includes an execution ID assigned for each execution of the workflow including the AI model 8.

Note that the execution time information acquired by the model data generation unit 23 from the AI model 8 is information indicating the AI model 8 at the time of executing the workflow, and the execution time information includes the basic information and one piece of the model state information (excluding the execution ID).

The relation data indicates a relationship between the workflow and the plurality of AI models 8 included in the workflow. The data structure of the relation data includes the execution ID that is set for each execution of the workflow, the scenario information 62 of the workflow, and the model state information of each AI model 8, and the first pointer to the corresponding scenario information and the second pointer to the corresponding model state information are added to the execution ID.

For example, the relation data with the execution ID (001) 61-1 includes an execution ID (001) 61-1, the scenario information 62, and pieces of model state information 631-1 and 632-1, and the first pointer to the scenario information 62 and the second pointer to the pieces of model state information 631-1 and 632-1 are added to the execution ID (001) 61-1.

Similarly, the relation data with the execution ID (002) 61-2 includes an execution ID (002) 61-2, the scenario information 62, and pieces of model state information 631-2 and 632-2, and the first pointer to the scenario information 62 and the second pointer to the model state information 631-2 and 632-2 are added to the execution ID (002) 61-2.

Hereinafter, an operation of the generation device 1 of the present embodiment will be described.

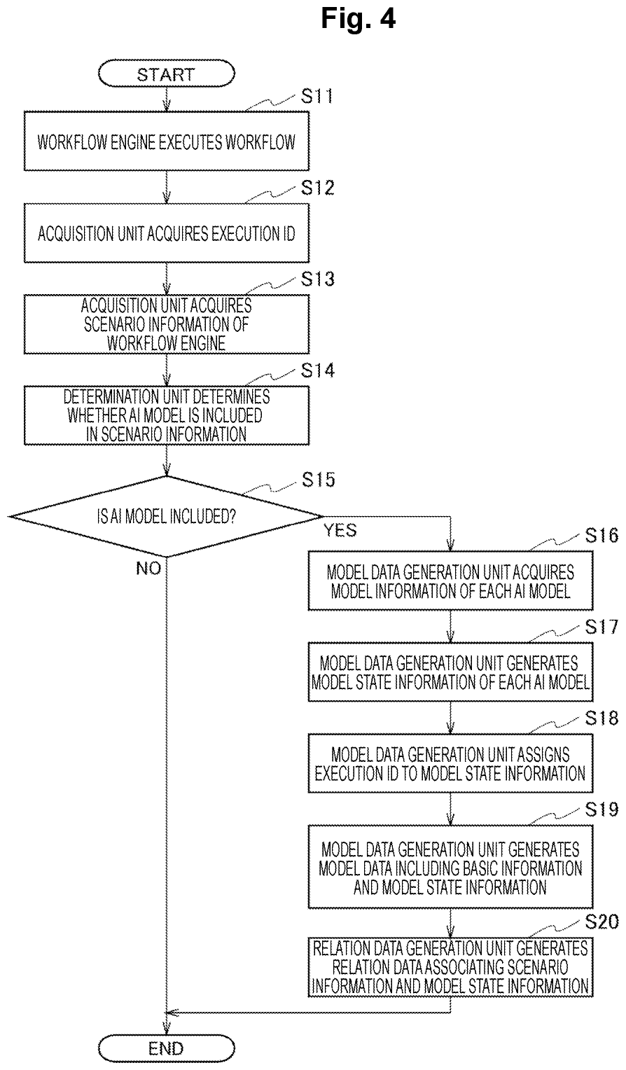

FIG. 4 is a flowchart illustrating an operation of the generation device 1. The workflow engine 4 executes a workflow and assigns an execution ID to the executed workflow (operation) (S11). Then, the workflow engine 4 transmits the execution ID to the generation device 1 as the execution information.

The acquisition unit 21 of the generation device 1 receives the execution ID via the input unit 11, and stores the execution ID in the ID storage unit 31 (S12). Upon receiving the execution information, the acquisition unit 21 acquires the scenario information from the workflow engine 4 via the input unit 11, sends the acquired scenario information to the determination unit 22, and causes the scenario information to be stored in the scenario information storage unit 33 (S13).

The determination unit 22 analyzes the scenario information and determines whether or not the AI model 8 is included in the execution procedure of the scenario information (S14). That is, the determination unit 22 determines whether or not the scenario information is the data flow using the AI model 8. When the AI model 8 is not included (S15: NO), the generation device 1 ends the processing.

When AI is included (S15: YES), the model data generation unit 23 acquires the model information from each AI model 8 included in the scenario information via the input unit 11, and causes the model information to be stored in the model information storage unit 32 (S16). The model information acquired here includes the basic information of the AI model 8 and the execution time information.

The model data generation unit 23 generates the model state information for each AI model 8 using the basic information and the execution time information (S17). For example, the model data generation unit 23 forks the current state from the execution time information to generate the model state information.

Specifically, the model data generation unit 23 takes a difference between the basic information held by the AI model 8 and the execution time information temporarily held by the AI model 8 at the time of executing the workflow, and generates the difference as the model state information.

The model data generation unit 23 assigns the execution ID acquired in S12 to each piece of model state information generated for each AI model 8 (S18).

The model data generation unit 23 generates or updates the model data for each AI model 8 (S19). The model data generation unit 23 generates model data including the basic information of the AI model 8 and the model state information to which the execution ID is assigned, and causes the model data to be stored in the model data storage unit 34.

Note that, when the model data already exists in the model data storage unit 34, the model data generation unit 23 updates the model data in the model data storage unit 34. That is, the model data generation unit 23 adds the model state information in S18 to the model data in the model data storage unit 34. Thus, every time the workflow is executed in S11, the model state information indicating the state of the AI model 8 at the time of execution is held in the model data.

The relation data generation unit 24 generates relation data by associating the scenario information acquired in S13 and the model state information generated in S18 with the execution ID acquired in S12 (S20). The relation data generation unit 24 outputs the generated relation data and causes the generated relation data to be stored in the relation data storage unit 35.

The generation device 1 of the present embodiment described above includes the acquisition unit 21 that acquires an execution ID of an executed workflow and scenario information of the workflow from the workflow engine 4, the first generation unit 23 that acquires basic information of each of AI models 8 included in the scenario information and execution time information at the time of execution of the workflow for each of the AI models 8, and generates model state information using the basic information and the execution time information, and the second generation unit 24 that generates relation data in which the model state information and the scenario information are associated with the execution ID.

As described above, in the present embodiment, the state of the AI model 8 can be managed in the execution unit of the workflow, whereby the reproducibility of the operation by the workflow using the AI model 8 can be ensured.

Further, in the present embodiment, every time the workflow is executed, the execution ID is dispensed, and the model state information at the time of execution of each AI model 8 is generated and associated with the execution ID. Thus, in the present embodiment, each AI model at the time of executing the workflow can be reproduced by searching for the model state information using the execution ID as a search key.

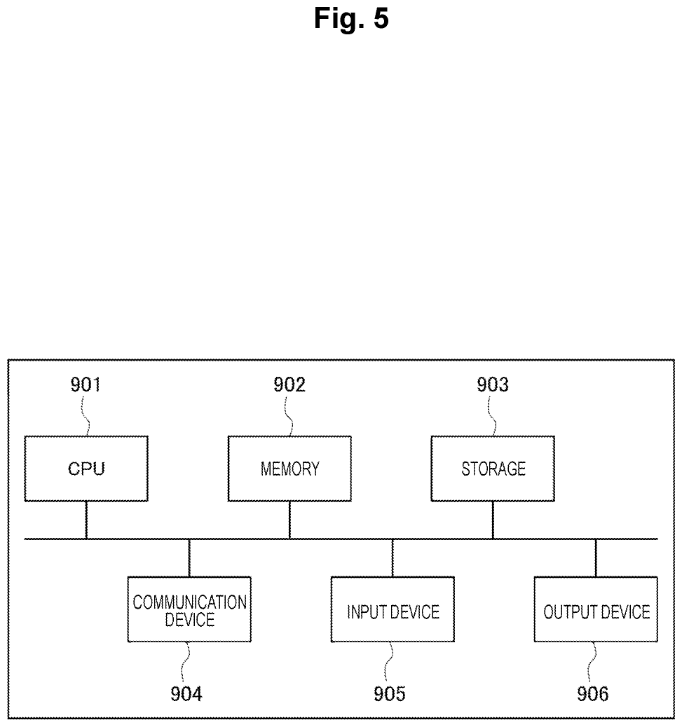

For the generation device 1 described above, for example, a general-purpose computer system as illustrated in FIG. 5 can be used. The computer system illustrated in the drawing includes a central processing unit (a CPU or a processor) 901, a memory 902, a storage 903 (a hard disk drive (HDD) or a solid state drive (SSD)), a communication device 904, an input device 905, and an output device 906. The memory 902 and the storage 903 are storage devices. In this computer system, each function of the generation device 1 is achieved by the CPU 901 executing the program for the generation device 1 loaded on the memory 902.

In addition, the generation device 1 may be implemented by one computer or may be implemented by a plurality of computers. In addition, the generation device 1 may be a virtual machine mounted on a computer.

The program for the generation device 1 can be stored in a computer-readable recording medium such as an HDD, an SSD, a universal serial bus (USB) memory, a compact disc (CD), or a digital versatile disc (DVD), or can be distributed via a network.

Note that the present invention is not limited to the embodiments and the modification, and various modifications can be made within the scope of the gist of the present invention.

### REFERENCE SIGNS LIST

1 Generation device
10 Input/output unit
11 Input unit
12 Output unit
20 Processing unit
21 Acquisition unit
22 Determination unit
23 Model data generation unit (first generation unit)
24 Relation data generation unit (second generation unit)
25 Search unit
30 Storage unit
31 ID storage unit
32 Model information storage unit
33 Scenario information storage unit
34 Model data storage unit
35 Relation data storage unit
4 Workflow engine
5 Data flow
7 Storage device
8, 8-1, 8-2 AI model
9 Operation terminal

1. A generation device, comprising one or more processors configured to perform operations comprising:
acquiring an execution ID of an executed workflow and scenario information of the workflow from a workflow engine;
acquiring basic information of each of AI models included in the scenario information and execution time information at a time of execution of the workflow for each of the AI models, and generates model state information using the basic information and the execution time information; and
generating relation data in which the model state information and the scenario information are associated with the execution ID.

2. The generation device according to claim 1, wherein the operations comprise:
assigning the execution ID to the model state information, and
generating, for each AI model, model data including the basic information and a plurality of pieces of model state information to which the execution ID is assigned.

3. The generation device according to claim 1, wherein the operations comprise:
generating a difference between the basic information and the execution time information as the model state information.

4. The generation device according to claim 1, further comprising:
determining whether or not an AI model is included in the scenario information.

5. A generation method performed by a generation device, the generation method comprising:
acquiring an execution ID of an executed workflow and scenario information of the workflow from a workflow engine;
acquiring basic information of each of AI models included in the scenario information and execution time information at a time of execution of the workflow for each of the AI models, and generating model state information using the basic information and the execution time information; and
generating relation data in which the model state information and the scenario information are associated with the execution ID.

6. A data structure of model data indicating an AI model, the model data being stored in a storage unit of a generation device, the data structure comprising:
basic information of the AI model; and
a plurality of pieces of model state information generated for each execution of a workflow including the AI model, wherein
the model state information includes an execution ID that is set for each execution of the workflow, and
a processing unit of the generation device
is used for processing of specifying the model state information and the basic information of each AI model including a designated execution ID.

7. (canceled)

8. (canceled)
